(19) United States
(12) Patent Application Publication
(10) Pub. No.: US 2026/0060861 A1
(43) Pub. Date: Mar. 5, 2026

(54) SLING FASTENERS FOR SECURE STORAGE

(71) Applicant: Liko Research & Development AB, Luleå (SE)

(72) Inventors: Neal Wiggermann, Batesville, IN (US); Jacob Banks, Mason, OH (US); Mathieu Bernard, Pluvigner (FR); Elin K. Dovervik, Luleå (SE); Nicholas A. Mann, Cincinnati, OH (US)

(73) Assignee: Liko Research & Development AB, Luleå (SE)

(21) Appl. No.: 19/312,995

(22) Filed: Aug. 28, 2025

Related U.S. Application Data
(60) Provisional application No. 63/689,067, filed on Aug. 30, 2024.

(51) Int. Cl. A61G 7/10

(52) U.S. Cl. CPC A61G 7/1023; A61G 7/1044; A61G 7/1074; A61G 2205/20

(57) ABSTRACT

A sling for supporting a subject is disclosed herein. The sling includes a body, one or more loops extending from the body, a first fastener coupled to a first portion of the body, and a second fastener coupled to a second portion of the body. The first fastener and the second fastener cooperate to enclose the one or more loops by selectively securing the first portion of the body to the second portion of the body in a folded configuration.

### CROSS-REFERENCE TO RELATED APPLICATION

The present disclosure claims the priority benefit of U.S. Provisional Patent Application Ser. No. 63/689,067, entitled “SLING FASTENERS FOR SECURE STORAGE” and filed on Aug. 30, 2024, the entire contents of which is incorporated by reference herein.

### BACKGROUND

### Field

The subject matter described herein relates to lifting devise for transporting and assisting persons with compromised mobility, and more specifically, to slings having features to facilitate storage and access.

### Technical Background

Caregivers in hospitals and other health care facilities may employ a lift system to transport patients suffering from limited mobility, or to assist those patients in their efforts to move about on their own. A representative lift system includes a hoist. One type of hoist is a freestanding, moveable frame unit that is supported on the floor by wheels or casters. Another type of hoist includes a carriage supported from the ceiling of the facility by a ceiling mounted rail system.

A representative lift system also includes a sling bar having a sling bar hub and a pair of arms that extend in laterally opposite directions from the sling bar hub. A hook-like element resides at the end of each arm. When the lift system is used to lift a subject, the sling bar is attached to the hoist.

A representative lift system is typically coupled to slings or the like for the purposes of supporting a subject thereon. These slings have particular features and dimensions that facilitate coupling to the person support apparatus and for supporting particular body parts of a subject. Such features and dimensions can make it difficult to properly store the slings while not in use.

### SUMMARY

According to at least one aspect of the present disclosure, a sling for supporting a subject thereon is disclosed. The sling includes a body, a pair of straps extending from the body, and a first layer coupled to the body. The first layer and the body define a storage pocket having an opening, wherein the storage pocket is sized to receive at least a portion of the body and the pair of leg straps therein in a folded configuration.

According to at least one aspect of the present disclosure, a sling for supporting a subject is disclosed. The sling includes a body, one or more loops extending from the body, a first fastener coupled to a first portion of the body, and a second fastener coupled to a second portion of the body. The first fastener and the second fastener cooperate to enclose the one or more loops by selectively securing the first portion of the body to the second portion of the body in a folded configuration.

According to at least one aspect of the present disclosure, a sling for supporting a subject thereon is disclosed. The sling includes a body having a pocket defined therein, and a stiffening insert including a first end and a second end positioned opposite the first end. The stiffening insert is sized to be received within the pocket, wherein the second end is positioned adjacent a base of the pocket when the stiffening insert is received in the pocket. The sling further includes a strap coupled to the stiffening insert, wherein the strap is wrapped around the stiffening insert for storage within the pocket when the sling is in an unfolded configuration, and wherein the strap is wrapped around the sling when the sling is in a folded configuration.

According to at least one aspect of the present disclosure, a sling for supporting a subject thereon is disclosed. The sling includes a body, one or more loops extending from the body, and a fastener to enclose the one or more loops by selectively securing the body in a folded configuration

### BRIEF DESCRIPTION OF THE DRAWINGS

The following detailed description of specific embodiments of the present disclosure can be best understood when read in conjunction with the following drawing, where like structure is indicated with like reference numerals and in which:

FIG. 1 depicts an illustrative sling for supporting a subject, according to one or more aspects of the disclosure;

FIG. 2A depicts an illustrative first step for folding the sling of FIG. 1, according to one or more aspects of the disclosure;

FIG. 2B depicts an illustrative second step for folding the sling of FIG. 1, according to one or more aspects of the disclosure;

FIG. 2C depicts an illustrative third step for folding the sling of FIG. 1, according to one or more aspects of the disclosure;

FIG. 2D depicts an illustrative fourth step for folding the sling of FIG. 1, according to one or more aspects of the disclosure;

FIG. 3A depicts the sling of FIG. 1 including one or more illustrative fasteners, according to one or more aspects of the disclosure;

FIG. 3B depicts the sling of FIG. 3A in a folded configuration, according to one or more aspects of the disclosure;

FIG. 4 depicts an illustrative stiffening insert of the sling of FIG. 1, according to one or more aspects of the disclosure;

FIG. 5A depicts a side view of another illustrative stiffening insert of the sling of FIG. 1, according to one or more aspects of the disclosure;

FIG. 5B depicts an end view of the stiffening insert of FIG. 5A according to one or more aspects of the disclosure;

FIG. 6A depicts the stiffening insert of FIGS. 5A-5B and the sling of FIG. 1 in a folded configuration, according to one or more aspects of the disclosure;

FIG. 6B depicts the stiffening insert of FIGS. 5A-5B and the sling of FIG. 1 in a folded configuration, according to one or more aspects of the disclosure;

FIG. 7A depicts the sling of FIG. 1 having a storage pocket with a closure mechanism, according to one or more aspects of the disclosure;

FIG. 7B depicts the sling of FIG. 1 having a storage pocket with a closure mechanism, according to one or more aspects of the disclosure;

FIG. 7C depicts the sling of FIG. 1 having a storage pocket with a closure mechanism;

FIG. 8A depicts the sling of FIG. 1 having a storage pocket, according to one or more aspects of the disclosure; and

FIG. 8B depicts the storage pocket of FIG. 8A supporting at least a portion of the sling therein, according to one or more aspects of the disclosure.

### DETAILED DESCRIPTION

Various slings are used for supporting at least a portion of a subject. More specifically, seated slings are used to facilitate transferring a subject from a seated position to another location and/or position. Such slings can include particular features specific for particular uses and/or subjects. Stated another way, slings can be provided in different shapes and/or sizes based at least in part on a desired use. In general, slings are manufactured from a material, such as polyester, nylon, and/or a combination thereof, for example, that provide a comfortable, smooth, durable, and/or washable surface. However, such materials are often slippery, or slick, to the touch, leading to complications in the storage and/or organization of such slings.

While the present disclosure uses the term “sling,” it should be appreciated that the present disclosure is not limited solely to such. That is, the systems and methods described herein can be used with any person support components, including those that are used in conjunction with overhead lift systems and/or for positioning subjects. For example, the systems and methods described herein may be used with or for straps, lifting sheets, and/or the like in addition to or in lieu of slings. As such, the term “sling” as used herein is intended to encompass slings, straps, lifting sheets, and/or the like.

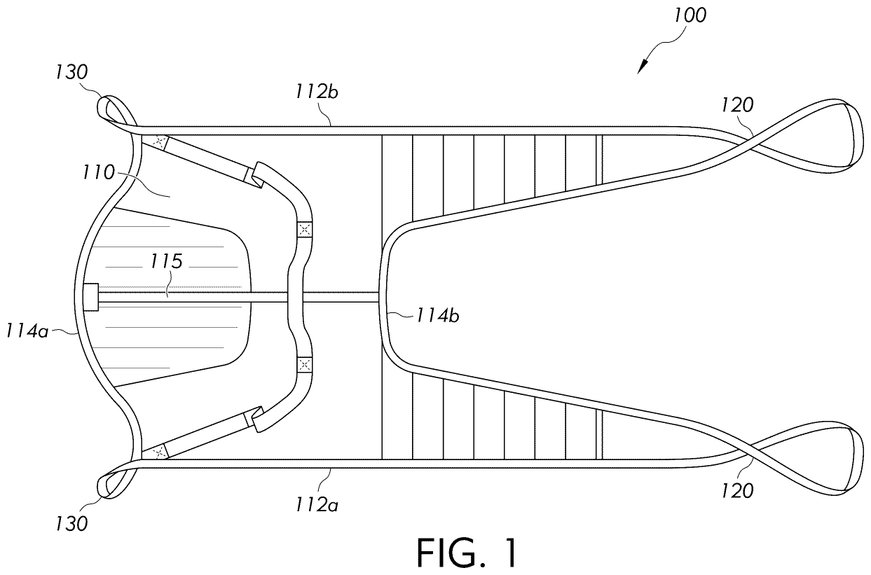

An exemplary sling 100 used in hospital, clinical, and/or other settings is depicted in FIG. 1. The sling 100 is a seated sling for use with a subject lift system. The sling 100 is configured to support a subject in a seated position as the subject is lifted to facilitate out-of-bed and up-from-bed activities. The sling 100 provides support to various parts of the subject's body, including the subject's back, arms, and legs, for example. Illustrative examples of slings include, but are not limited to, the Liko® UniversalSling™, the Liko® UltraSling™, the Liko® HygieneSling™, the Liko® HygieneVest™, the Liko® ComfortSling™, the Liko® AmputccSling™, the Liko® SilhouetteSling™, the Liko® MultiStrap™, the Liko® RepoSheet®, the Liko® Safety Vest™, the Liko® SupportVest™, the Liko® ComfortVest™, and various other slings, straps, sheets, and/or the like from Baxter (Batesville, Indiana).

The sling 100 includes a body 110 for supporting the subject thereon. The body 110 of the sling 100 can be used to support a subject's core region, pelvis region, shoulder region, head region, and/or neck region. The sling 100 can include one or more straps and/or loops extending therefrom. The one or more straps and/or loops can be used to support a portion of the subject thereon and/or to couple the sling 100 to equipment, for example. More specifically, in various instances, at least a portion of the subject's legs can be supported by a pair of leg straps 120 extending from the body 110 of the sling 100. In various instances, a pair of shoulder loops 130 extend from the body 110 for attachment to a lift system. While the particular seated sling 100 is shown in FIG. 1, the present disclosure applies to any sling for supporting at least a portion of a subject thereon.

A perimeter of the body 110 is defined by four perimeter edges. A first perimeter edge 112a extends along a first side of the sling 100 opposite of a second perimeter edge 112b. A third perimeter edge 114a extends between the first perimeter edge 112a and the second perimeter edge 112b opposite of a fourth perimeter edge 114b extending between the first perimeter edge 112a and the second perimeter edge 112b. A centerline 115 of the body 110 is defined between the third perimeter edge 114a of the sling 100 and the fourth perimeter edge 114b of the sling 100.

The sling 100 may generally be constructed of any type of material, and such materials are not limited by the present disclosure. In some instances, the sling 100 may be constructed of a material that has strength properties allowing the sling 100 to support the weight of an average human subject. In some instances, the sling 100 may formed from a textile comprising natural fibers such as, for example, wool, flax, cotton, hemp, or the like. In some instances, the sling 100 may be formed from one or more synthetic fibers such as, for example, polyester, aramid, acrylic, nylon, spandex, olefin, carbon fiber, or the like. In still other instances, the sling 100 may be formed from a textile comprising natural fibers that are derived from animal (protein), vegetable (cellulose), and/or mineral sources. Illustrative examples of natural fibers include, but are not limited to, cellulose (staple) fibers such as bast, leaf, seed hair, cane, grass, and reed; protein (staple) fibers such as hair, wool, and/or filaments (e.g., secretions such as silk); and mineral fibers such as asbestos, glass, gold, silver, and/or the like. In some instances, the sling 100 may be formed from one or more manufactured fibers such as manmade (human made), regenerated, or synthetic fibers having a chemical composition that is organic or inorganic or derivatives thereof. In some instances, the sling 100 may be formed from one or more fibers having a chemical composition that is organic or inorganic. Illustrative examples of organic polymer fibers from natural sources include, but are not limited to, acetate, alginate, cupro, elastodiene, lyocell, model, triacetate, and viscose. Illustrative examples of organic fibers made from synthetic polymers include, but are not limited to, acrylic, aramid, chlorofibre, elastane, elastodiene, elastoelfin, elastomultiester, flurofiber, melamine, modacrylic, polyamide, polyester, polyethelene, polyimide, polylactic acid, polypropylene, polypropylene/polyamide biocomponent, and vinylal. Illustrative examples of inorganic fibers include, but are not limited to, carbon, ceramic, glass, and metal.

In some instances, the sling 100 may be constructed such that various surfaces thereof (e.g., one or more first major surfaces) are constructed of or coated with a high-friction material and/or various other surfaces thereof (e.g., one or more second major surfaces) are constructed of or coated with a low-friction material. The low-friction material is generally any material having a coefficient of friction that is lower than a coefficient of friction of the high-friction material. In some instances, the low-friction material may be any material that has a coefficient of friction that is lower than a coefficient of friction of an uncoated or untreated surface of the sling 100. In some instances, the high-friction material may be any material that has a coefficient of friction that is the same or higher than a coefficient of friction of an uncoated or untreated surface of the sling 100. The coefficient of friction is a quantitative measure of the friction between two surfaces, and is influenced by factors that include surface roughness and environmental conditions such as, but not limited to, temperature and humidity. In some instances, the coefficient of friction refers to a maximum coefficient of friction measured at a normal load of 30 N as measured in a standard test equipment, such as, for example, a vial overlay test jig. In one example, a low coefficient of friction may be about 0.9 or less relative to an uncoated surface, including, about 0.9, about 0.8, about 0.7, about 0.6, about 0.5, about 0.4, about 0.3, about 0.2, about 0.1 or less relative to an uncoated surface, or any range or value between any two of these values. In another example, a high coefficient of friction may be about 1.0 or greater relative to an uncoated surface, including about 1.0, about 1.5, about 2.0, about 2.5, about 3.0, about 3.5, about 4.0 or greater relative to an uncoated surface, or any range or value between any two of these values. In some instances, a surface of the sling 100 having the low-friction material may be constructed such that a low-friction coating on the surface is directional. That is, for example, the surface of the sling 100 may exhibit a lower coefficient of friction along a length of material relative to a coefficient of friction along the a width of the material that is substantially orthogonal to the length.

In some instances, the sling 100 may have one or more identifiers, or indicia, thereon. The location and/or type of identifiers are not limited by the present disclosure, and may generally be any location and/or type. In some instances, the identifiers may provide an indication of uses, configurations, sizes, dimensions, features, an arrangement of various portions of the sling 100 with respect to a subject, folding/storage instructions, and/or the like. For example, the identifiers may provide one or more indicators to a subject about how to fold or arrange the sling 100 or portions thereof for the purposes of storage, as described herein. Illustrative examples of identifiers include, but are not limited to, lines, shapes, images, text, anatomical drawings, measurement marks (e.g., a ruler), or the like. In some instances, the identifiers may be color coded or otherwise visually distinguishable for the purposes of indicating a particular arrangement, positioning, and/or the like.

The shoulder loops 130 provide a connection point for the sling 100 to be connected to another object. For example, in certain instances, the shoulder loops 130 are used as a connection point for connecting the sling 100 to a sling bar of an overhead lift (e.g., a freestanding lift or a rail mounted lift). The shoulder loops 130 are coupled to a portion of the sling (e.g., the first perimeter edge 112a, the second perimeter edge 112b, the third perimeter edge 114a, and/or the fourth perimeter edge 114) by any means of coupling, including, but not limited to, stitching, welding, use of fasteners (e.g., rivets or the like), use of adhesives, and/or the like. In some instances, the shoulder loops 130 are integrated with the material of the sling 100. That is, the loops are formed as an extension of the material of the sling 100 such that the sling 100 (including the loops) are all formed from a single piece of material.

The shoulder loops 130 may generally be constructed of any type of material, and such materials are not limited by the present disclosure. In some instances, the shoulder loops 130 may be constructed of a material that has strength properties that allow the sling 100, together with the shoulder loops 130, to support the weight of an average human subject. In some instances, the shoulder loops 130 may be formed from a textile comprising natural fibers such as, for example, wool, flax, cotton, hemp, or the like. In some instances, the shoulder loops 130 may be formed from one or more synthetic fibers such as, for example, polyester, aramid, acrylic, nylon, spandex, olefin, carbon fiber, or the like. In some instances, the shoulder loops 130 may be formed of the same material as the material used for the remainder of the sling 100. In other instances, the shoulder loops 130 may be formed from a different material than the material used for the remainder of the sling 100.

The leg straps 120 provide a connection point for the sling 100 to support, or otherwise be connected to, another object. For example, the leg straps 120 are used to support at least a portion of a subject's legs thereon. In various instances, the leg straps 120 are used as a connection point for connecting the sling 100 to a sling bar of an overhead lift (e.g., a freestanding lift or a rail mounted lift). The leg straps 120 are coupled to a portion of the sling (e.g., the first perimeter edge 112a, the second perimeter edge 112b, the third perimeter edge 114a, and/or the fourth perimeter edge 114) by any means of coupling, including, but not limited to, stitching, welding, use of fasteners (e.g., rivets or the like), use of adhesives, and/or the like. In some instances, the leg straps 120 are integrated with the material of the sling 100. That is, the straps are formed as an extension of the material of the sling 100 such that the sling 100 (including the straps) are all formed from a single piece of material.

The leg straps 120 may generally be constructed of any type of material, and such materials are not limited by the present disclosure. In some instances, the leg straps 120 may be constructed of a material that has strength properties that allow the sling 100, together with the leg straps 120, to support the weight of an average human subject. In some instances, the leg straps 120 may be formed from a textile comprising natural fibers such as, for example, wool, flax, cotton, hemp, or the like. In some instances, the leg straps 120 may be formed from one or more synthetic fibers such as, for example, polyester, aramid, acrylic, nylon, spandex, olefin, carbon fiber, or the like. In some instances, the leg straps 120 may be formed of the same material as the material used for the remainder of the sling 100. In other instances, the leg straps 120 may be formed from a different material than the material used for the remainder of the sling 100.

As discussed herein, the storage and/or organization of slings when not in use proves difficult as the slings are slick and do not include sufficient fastening means to maintain the slings in a desirable configuration. Conventional storage solutions result in the slings being hard to easily identify and/or locate when needed.

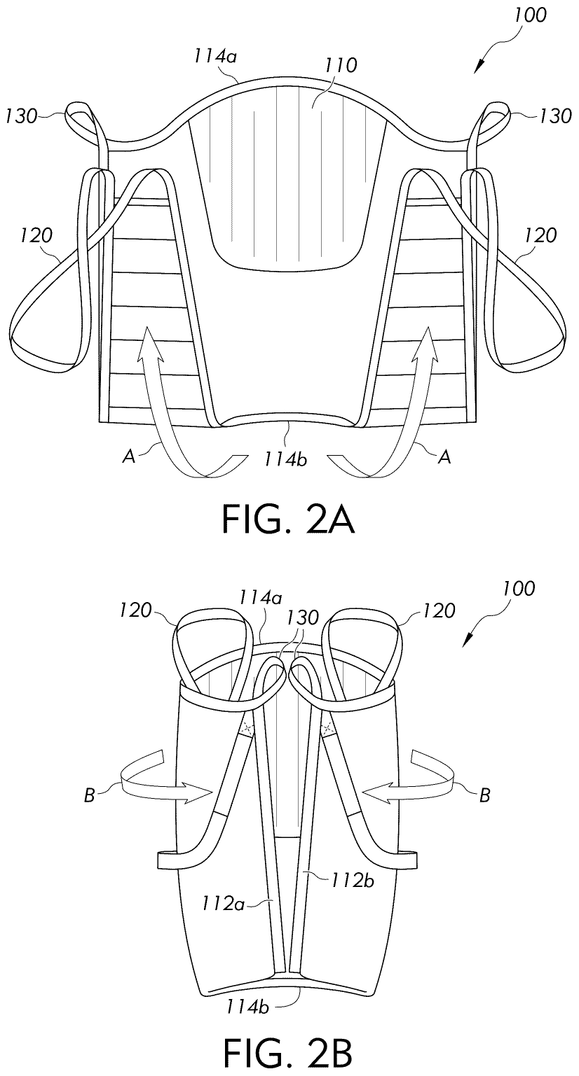

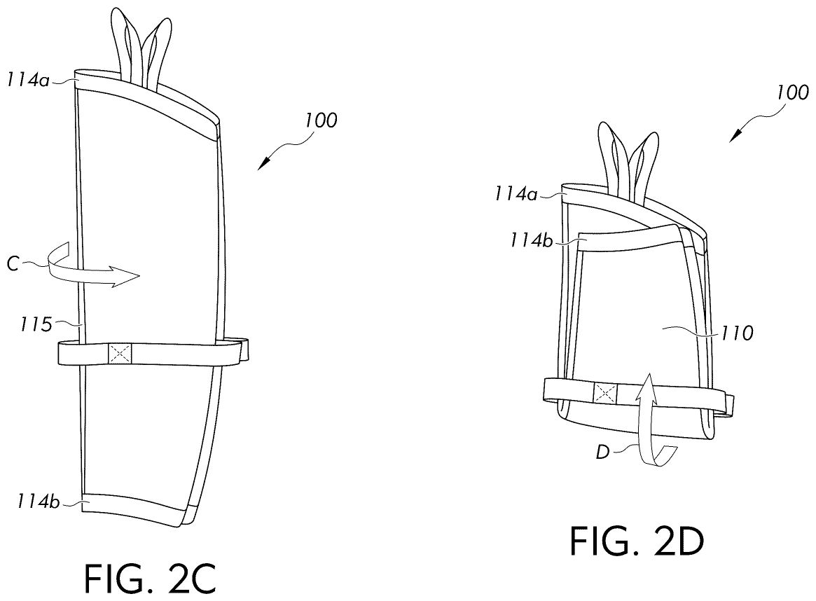

An exemplary conventional method for folding a sling is depicted in FIGS. 2A-2D. Notably, the steps of the conventional folding method described herein can be performed in any suitable order. More specifically, as shown in FIG. 2A, a first step for folding the sling 100 involves folding the sling 100 in half, lengthwise, by bringing the leg straps 120 toward the third perimeter edge 114a and/or the shoulder loops 130 as represented by arrows A. A second step for folding the sling 100 is shown in FIG. 2B where first and second perimeter edges 112a, 112b of the sling 100 are folded toward one another as represented by arrows B. Once the first and second perimeter edges 112a, 112b have been folded towards one another, the sling 100 is folded along the centerline 115 as shown in FIG. 2C and represented by arrow C. The conventional method ends with a fourth step where the fourth perimeter edge 114b is folded toward the third perimeter edge 114a as shown in FIG. 2D and represented by arrow D. Notably, at no point were any portions of the sling 100 secured to one another by a fastening means to maintain the sling 100 in the folded configuration. As such, the sling 100 is susceptible to unraveling out of its folded configuration, for example. Consequently, this conventional method depicted in FIGS. 2A-2D may be undesirable and improvements to the design of the sling 100 as described hereinbelow may mitigate the issues associated with unraveling out of the folded configuration, thereby allowing for the sling 100 to be folded and secured in a compact manner to facilitate case of storage, categorization, and use.

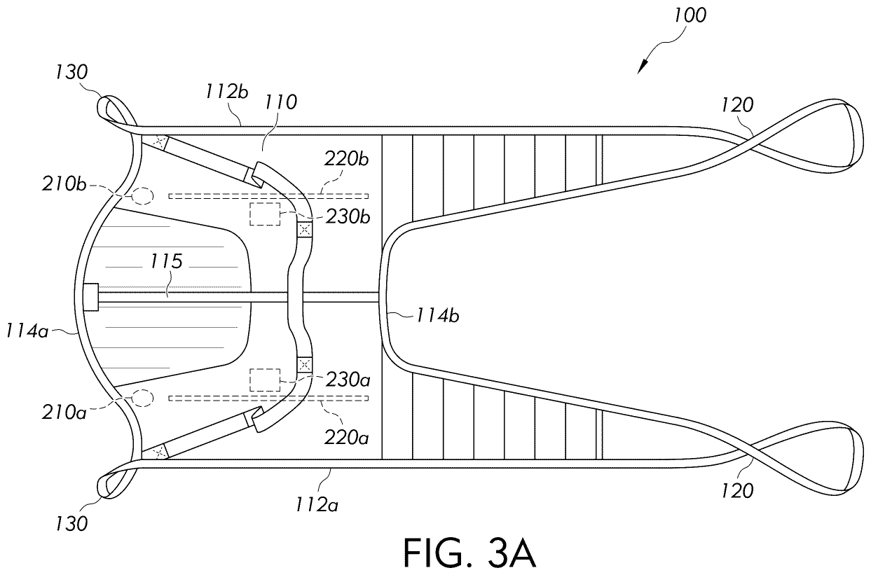

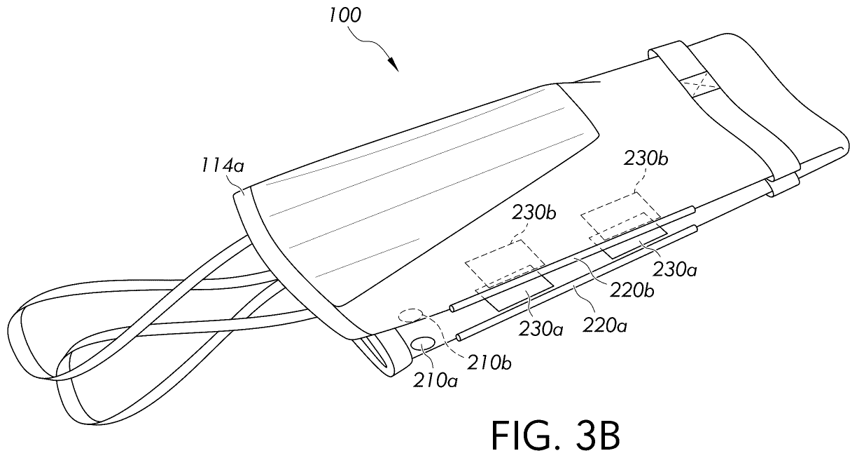

FIG. 3A depicts various fasteners 210, 220, 230 selectively coupled to the sling 100 for maintaining the sling 100 in the folded configuration. The fasteners 210, 220, 230 can be coupled to the sling 100 by any suitable manner, in any suitable position, and in any suitable frequency and/or combination.

More specifically, the fasteners 210, 220, 230 are intended to be positioned in location(s) on the sling 100 such that the fasteners 210, 220, 230 do not interfere with, or otherwise cause irritation to, a subject supported thereon. The placement of the fasteners 210, 220, 230 is significant in an effort to avoid adding a substantial, or otherwise significant, thickness to one or more portions of the sling.

For example, one or more pairs of first fasteners 210a, 210b can be coupled to the body 110 of the sling 100 adjacent the third perimeter edge 114a. A first component 210a of the pair of first fasteners is positioned on a first side of the centerline 115 while a corresponding second component 210b of the pair of first fasteners is positioned on a second side of the centerline 115. One or more pairs of second fasteners 220a, 220b can be coupled to the body 110 of the sling 100 extending between the third perimeter edge 114a and the fourth perimeter edge 114b. A first component 220a of the pair second fasteners can be located on the body 110 at a location between the centerline 115 and the first perimeter edge 112a, while a second component 220b of the pair of second fasteners can be located on the body 110 at a location between the centerline 115 and the second perimeter edge 112b. As shown in FIG. 3A, the one or more pairs of first fasteners 210a, 210b are laterally aligned with the one or more pairs of second fasteners 220a, 220b; however, instances are envisioned where the one or more pairs of first fasteners 210a, 210b are laterally offset from the one or more pairs of second fasteners 220a, 220b.

One or more pairs of third fasteners 230a, 230b can be coupled to be body 110 of the sling 100 at a location between the third and fourth perimeter edges 114a, 114b on opposing sides of the centerline 115, respectively. As shown in FIG. 3A, the one or more pairs of third fasteners 230a, 230b are positioned closer to the centerline 115 than the one or more pairs of second fasteners 220a, 220b. Stated another way, the one or more pairs of third fasteners 230a, 230b are laterally offset from the one or more pairs of second fasteners 220a, 220b and the one or more pairs of first fasteners 210a, 210b. In various instances, the one or more pairs of third fasteners 230a, 230b can be laterally aligned with the one or more pairs of first fasteners 210a, 210b.

While all three fasteners 210, 220, 230 are depicted as being coupled to the sling 100 in FIG. 3A, it is envisioned that the sling 100 can include any suitable combination of fasteners 210, 220, 230. Stated another way, the sling 100 can only include the one or more pairs of first fasteners 210, the one or more pairs of second fasteners 220, the one or more pairs of third fasteners 230, or the sling 100 can include any combination of the fasteners 210, 220, 230, for example.

In various instances, the fasteners 210, 220, 230 can be a pair of magnets, a snap mechanism, a zipper mechanism, an interlocking fastening mechanism, a hook and loop fastening mechanism, and/or the like. More specifically, in instances where the fasteners 210, 220, 230 include a pair of magnets, the fasteners can include one or more corresponding magnets of opposite polarity so as to facilitate a magnetic attraction therebetween. In various instances, magnetic fasteners can include one magnet and one magnetic piece of metal, for example. As discussed herein, comfort of the subject is considered in determining a placement of the one or more fasteners 210, 220, 230 such that a particular fastening mechanism can be more desirable in one location over another. As the one or more pairs of third fasteners 230a, 230b are positioned away from the perimeter edges of the sling 100, a flat, less bulky fastening mechanism can be desirable. For example, a hook and loop fastening mechanism can be used as the one or more pairs of third fasteners 230a, 230b such that a hook fastener can be positioned on a first side of the centerline 115 as the first component 230a, while a corresponding loop fastener can be positioned on a second side of the centerline 115 as the second component 230b.

Moreover, as shown in FIG. 3B, a second pair of third fasteners 230a, 230b can be coupled to the sling 100. In such instances, the first component 230a can be a loop fastener positioned on the first side of the centerline 115, while a hook fastener can be positioned on the second side of the centerline 115 as the second component 230b. As such, the first components 230a positioned on the first side of the centerline 115 can couple to one another, and the second components 230b positioned on the second side of the centerline 115 can couple to one another. Such coupling can occur in addition to or in the alternative of the first components 230a coupling to the second components 230b. In various instances, a fastener component on the first side of the centerline 115 can be longitudinally and/or laterally aligned with the associated fastener component on the second side of the centerline 115. Similarly, a fastener component 230a on the first side of the centerline 115 can be longitudinally aligned with another fastener component 230a on the first side of the centerline 115.

As shown in FIG. 3B, the associated components 210a, 210b of the pair of first fasteners, the associated components 220a, 220b of the pair of second fasteners, and the associated components 230a, 230b of the pair of third fasteners are aligned as a subject folds the sling 100 into the desired folded configuration. The presence of any fastener 210, 220, 230 allows for the sling 100 to be maintained, or otherwise secured, in the folded configuration as the perimeter edges 112a, 112b, 114a, 114b are folded toward one another to achieve the folded configuration of the sling 100. Stated another way, a force is applied to the sling 100 suitable to overcome the fastening mechanism of the fasteners 210, 220, 230 in order to transition the sling 100 from the folded configuration to an unfolded configuration.

In various instances, the fasteners 210, 220, 230 can be used to couple, or otherwise secure, a first sling to an adjacently placed second sling. Such coupling facilitates uniform and/or organized storage of a plurality of slings, as such stacked, or otherwise stored, slings will not slip with respect to one another and will instead form a single unit, stack, and/or pile. In various instances, the fasteners 210, 220, 230 of the first sling can be aligned with the fasteners 210, 220, 230 of the second such that the first sling and the second sling are compactly and/or efficiently stacked, or otherwise coupled, to one another. Such efficient storage allows for the plurality of slings to take up a minimal amount of space while still remaining easily accessible. More specifically, for example, in instances where at least one of the fasteners 210, 220, 230 include magnets, the fasteners 210, 220, 230 can be magnetically attracted to, or otherwise drawn to, the magnetic fasteners 210, 220, 230 of an adjacent sling. In various instances, where at least one of the fasteners 210, 220, 230 include snaps, a first fastener component 210, 220, 230 of the first sling can be snapped to a complementary second fastener component 210, 220, 230 of the second sling. In any event, an attraction, or other coupling means, between complementary components of fasteners from adjacent slings allow the plurality of slings to be neatly stacked, or otherwise organized, during storage.

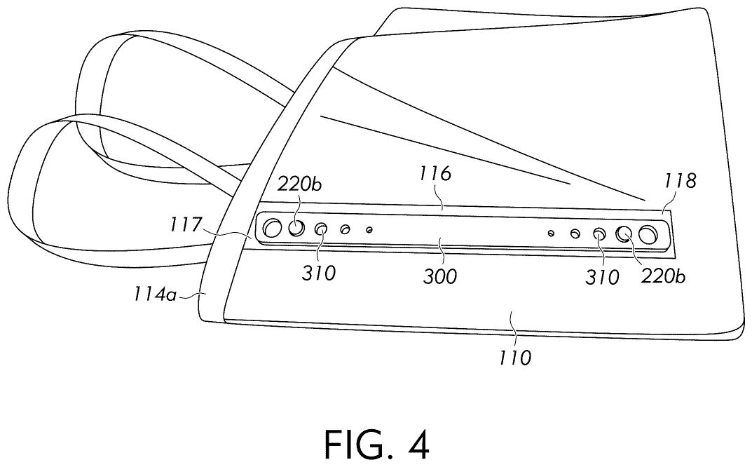

Referring now to FIG. 4, the body 110 of the sling 100 further defines a pocket 116 thereon for receiving a stiffening insert 300. The pocket 116 includes an opening 117 located adjacent the third perimeter edge 114a of the sling 100 and a base 118 located near the fourth perimeter edge 114b of the sling. The pocket 116 is sized to slidably and/or removably receive the stiffening insert 300 therein; however, any attachment mechanism for securely coupling the stiffening insert 300 to the body 110 of the sling 100 is envisioned. Alternative attachment mechanisms can include, for example hook and loop connections, magnetic connections, and/or any other suitable attachment mechanism between the body 110 of the sling 100 and the stiffening insert 300.

In various instances a plurality of pockets 116 are defined along the body 110 of the sling in locations adjacent to a subject's back when in use, for example. In various instances, the plurality of pockets 116 can include pockets 116 of varying sizes to correspondingly receive stiffening inserts 300 of varying sizes. As such, additional rigidity, or structure, can be provided to a particular portion of the sling 100 in need of increased support and/or subject to greater forces from a subject supported thereon, for example.

The stiffening insert 300 provides structure and/or support to facilitate the sling 100 in supporting the subject thereon. The stiffening insert 300 can be made out of any suitable material that has sufficient rigidity so as to provide a desired support to a subject, while also being sufficiently flexible to mold into a desired orientation. Such materials can include, for example, a metal, a plastic, and/or the like. In various instances, the stiffening insert 300 has a rectangular perimeter and is sufficiently flat so as to be flexible and/or so as to not cause a significant bulge and/or protrusion when positioned in the pocket 116, for example. In various instances, the stiffening insert 300 includes one or more apertures 310 defined therein. In various instances, the apertures 310 are throughholes. In other instances, the apertures 310 do not extend through an entire thickness of the stiffening insert 300. In various instances, a component of the one or more second fasteners 220a, 220b can be removably coupled to the stiffening insert 300 by way of the apertures 310. Stated another way, a component of the one or more second fasteners 220a, 220b can be positioned, or otherwise friction-fit within, an aperture 310 defined in the stiffening insert 300. The apertures 310 can include different diameters to accommodate fasteners of different sizes, for example. More specifically, the stiffening insert 300 depicted in FIG. 4 includes two magnets 220b for coupling to magnets positioned on an opposite side of the centerline 115; however, any suitable number of magnets 220b is envisioned.

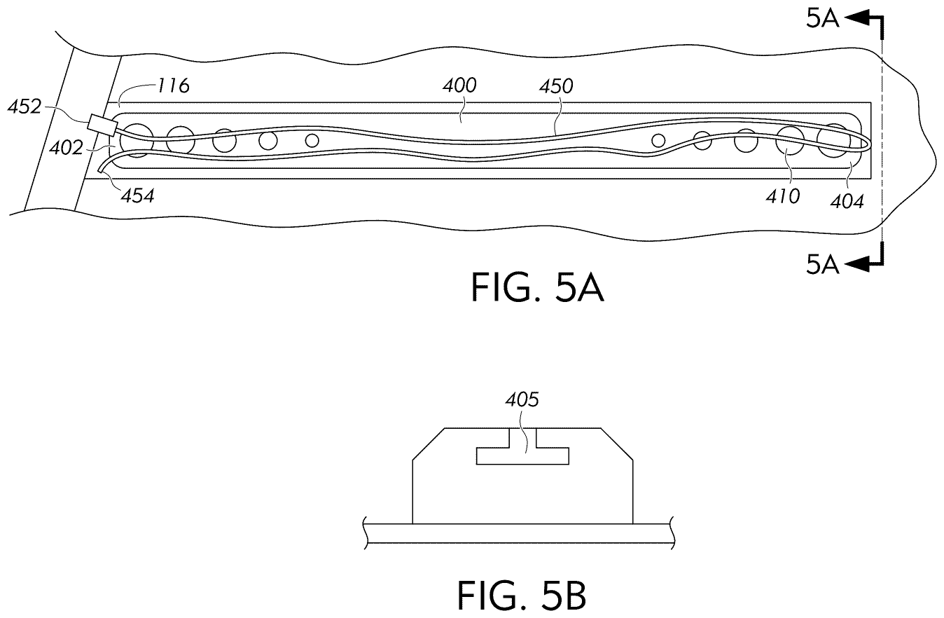

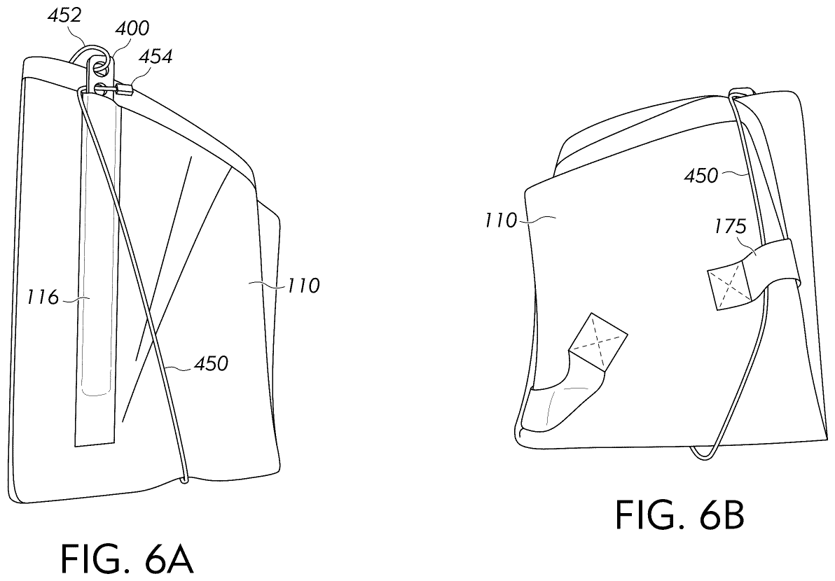

FIGS. 5A-6C depict a stiffening insert 400 similar in many respects to the stiffening insert 300. For example, the stiffening insert 400 is sized to be slidably and/or removably received within the pocket 116 defined on the body 110 of the sling 100. The stiffening insert 400 includes a first end 402 and a second end 404. The first end 402 is positioned adjacent the opening 117 of the pocket 116 while the second end 404 is positioned adjacent the base 118 of the pocket 116 when the stiffening insert 400 is received in the pocket 116. A notch 405, or other suitable cut-out, is defined on the second end 404 of the stiffening insert 400. The notch 405 is sized to receive at least a portion of a strap 450 therethrough such that the strap 450 is maintained in a desirable orientation.

The strap 450 can be used to secure the sling 100 in the folded configuration while remaining within the pocket 116 when the sling 100 is being used and/or in the unfolded configuration. More specifically, the strap 450 includes a first end 452 and a second end 454. The first end 452 of the strap 450 is coupled to the first end 402 of the stiffening insert 400. In various instances, the first end 452 can be coupled to the first end 402 of the stiffening insert 400 by an aperture 410 defined therein. In various instances, the apertures 410 are throughholes. In other instances, the apertures 410 do not extend through an entire thickness of the stiffening insert 400. However, the strap 450 can be coupled to the stiffening insert 400 in any suitable manner. While described as a strap 450, any suitable strap-like component is envisioned such as a ribbon, a string, and/or a rope, for example.

The second end 454 of the strap 450 is not coupled to the stiffening insert 400. Instead, when the sling 100 is in the unfolded configuration, the second end 454 of the strap 450 is wrapped around the second end 404 of the stiffening insert 400 passing through the notch 405 and returning toward the first end 402 of the stiffening insert 400. In such instances, the stiffening insert 400 and the strap 450 are both housed in the pocket 116 while the sling 100 is in use in the unfolded configuration.

When the sling 100 is folded for storage, the stiffening insert 400 and the strap 450 can be slidably removed from the pocket 116. The strap 450 can be unwound from the stiffening insert 400 such that the first end 452 of the strap 450 remains coupled to the stiffening insert 400. The second end 454 of the strap 450 is used to wrap around the sling 100 in the folded configuration. In various instances, as shown in FIG. 6A, the second end 454 of the strap 450 can couple to an aperture 410 of the stiffening insert 400 to secure the sling 100 in the folded configuration. As shown in FIG. 6B, the strap 450 can pass through a loop 175, or couple to another strap, defined on the sling 100 before returning to the stiffening insert 400 to provide additional support to the folded sling 100. In other instances, the second end 454 of the strap can couple to a strap or the loop 175, defined on the sling 100 to secure the sling 100 in the folded configuration. In various instances, the straps and loops defined on the sling 100 can be coupled to one another in any suitable combination to provide additional stability to the sling 100 in the folded configuration.

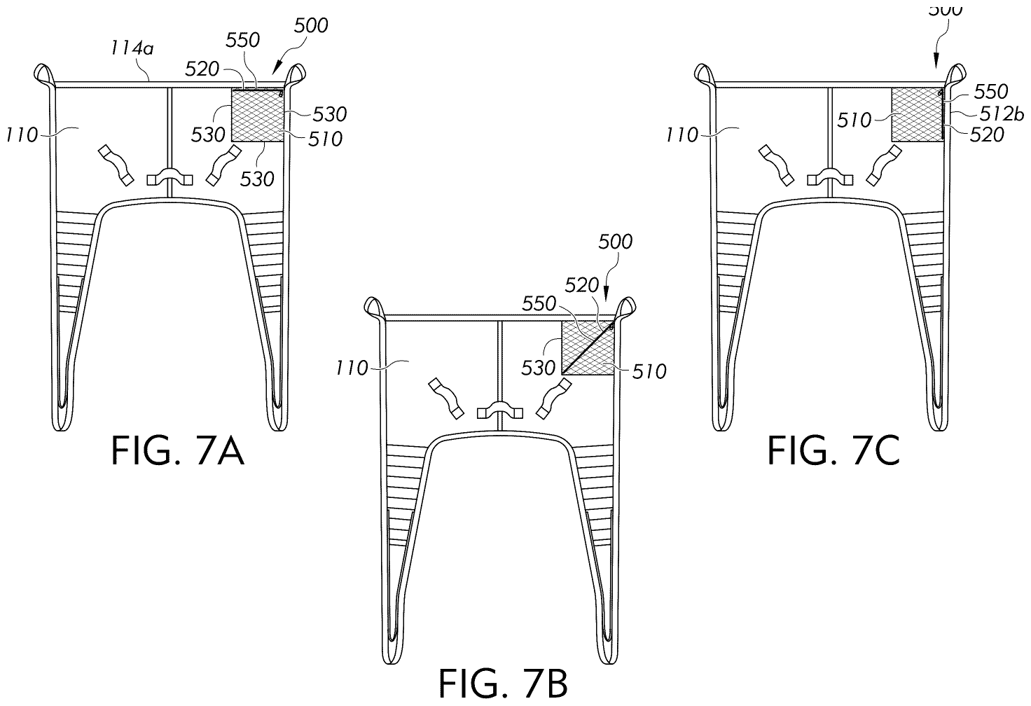

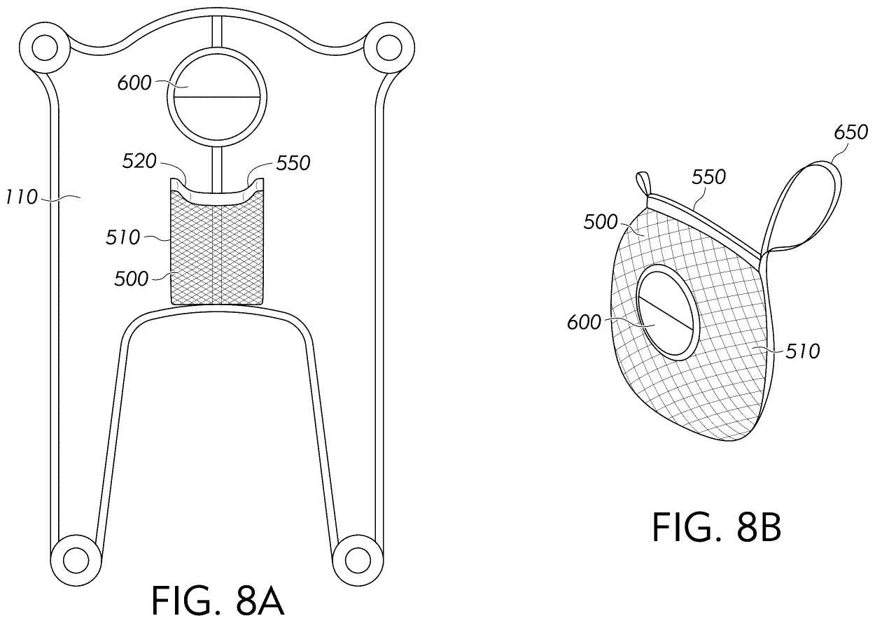

Referring now to FIGS. 7A-8B, the sling 100 can include a storage pocket 500 defined thereon for receiving at least a portion of the sling 100 in the folded configuration. The storage pocket 500 is defined by the body 110 of the sling 100 and a first layer of material 510. The first layer of material 510 can be coupled to the body 110 of the sling 100 in any suitable manner, such as by being sewn together, for example. The storage pocket 500 includes an opening 520 and a base 320. The storage pocket 500 is sized to store a majority of the sling including any straps and loops defined thereon-except for the portion of the body 110 that defines the storage pocket 500. The storage pocket 500 is sized to store the sling 100 when the sling 100 is neatly folded as well as when the sling 100 is haphazardly received within the storage pocket 500.

In various instances, as shown in FIGS. 7A-7C, the storage pocket 500 is positioned adjacent a perimeter edge of the storage pocket 500, such as the perimeter edges 112b and 114a; however, the storage pocket 500 can be placed in any suitable location that allows for the sling 100 to be folded thereinto and does not create an irritant to the subject. For example, as shown in FIG. 8A, the storage pocket 500 is positioned adjacent the fourth perimeter edge 114b.

A closure mechanism 550 disposed on the first layer of material 510 to securely close the opening 520 of the storage pocket 500. In various instances, the closure mechanism 550 includes a zipper mechanism, a fold-over closure mechanism, snaps, magnets, an interlocking fastening mechanism, a hook and loop fastening mechanism, and/or the like. As depicted in FIGS. 7A-7C, the opening 520 can be located on any portion of the storage pocket 500 and in any suitable orientation. More specifically, as shown in FIG. 7A, the opening 520 and, thus the closure mechanism 550, can extend horizontally along a portion of the first layer of material 510 adjacent the third perimeter edge 114a of the sling 100. Alternatively, as shown in FIG. 7B, the opening 520 and, thus the closure mechanism 550, can extend diagonally across the first layer of material 510. Furthermore, as shown in FIG. 7C, the opening 520 and, thus the closure mechanism 550, can extend vertically along a portion of the first layer of material 510 adjacent the second perimeter edge 112b of the sling 100.

As shown in FIGS. 8A and 8B, the sling 100 further includes an identifier 600 thereon to communicate a feature of the sling 100 to a subject. In various instances, the identifier 600 is displayed on the body 110 of the sling 100. Additionally or alternatively, the identifier 600 is displayed on the storage pocket 500, such as on the first layer of material 510. The identifier 600 can communicate, or otherwise relates to, a size and/or a model of the particular sling. Such identifier 600 can include a particular color associated with a particular feature and/or one or more alphanumeric characters associated with the particular feature. In various instances, the first layer of material 510 is transparent, or at least substantially transparent.

In an effort to easily identify stored slings, the identifier 600 is readily visible to a subject. In various instances, for example, the identifier 600 is readily visible, or otherwise apparent, when the sling 100 is in the folded configuration, when the sling 100 is being stored, and/or when the body 110 is folded within the storage pocket 500, for example. The visibility of the identifier 600 allows a subject to be able to quickly identify, or otherwise locate, a particular sling 100 for a particular purpose. Stated another way, many slings having different characteristics, such as size, material, and/or type, can be stored in a particular location. The visibility of the identifier 600 decreases the time a subject must spend to locate a desired sling, for example. In various instances, the visibility of the identifier 600 allows a subject to be able to place a cleaned, or otherwise unused, sling in a proper location to maintain an organized storage location. As such, the storage pocket 500 is made of a substantially transparent material that allows for the subject to observe the identifier 600 therethrough. For example, the first layer of material 510 can include a mesh material.

In various instances, as shown in FIG. 8B, the folded sling 100 further includes a support handle 650, or loop, to allow the folded sling 100 to be stored on a hook, a sling bar, and/or, a hanger, for example. In various instances, the support handle 650 can be the one or more shoulder loops 130 of the sling 100 or any other loop defined on the sling 100. Alternatively and/or additionally, the support handle 650 can be additionally coupled to the storage pocket 500.

Further aspects of the embodiments described herein are provided by the subject matter of the following clauses:

A sling for supporting a subject thereon, the sling comprising a body; a pair of straps extending from the body; and a first layer coupled to the body, the first layer and the body defining a storage pocket having an opening, wherein the storage pocket is sized to receive at least a portion of the body and the pair of straps therein in a folded configuration.

The sling of any of the preceding clauses, wherein the sling comprises an identifier of the sling.

The sling of any of the preceding clauses, wherein the first layer comprises the identifier.

The sling of any of the preceding clauses, wherein the body comprises the identifier.

The sling of any of the preceding clauses, wherein the first layer is substantially transparent such that the identifier is visible through the first layer.

The sling of any of the preceding clauses, wherein the first layer comprises a mesh material.

The sling of any of the preceding clauses, wherein the identifier relates to a size of the sling.

The sling of any of the preceding clauses, wherein the identifier relates to a type of the sling.

The sling of any of the preceding clauses, wherein the medical sling further comprises a support handle.

The sling of any of the preceding clauses, wherein the pocket comprises a loop coupled thereto.

The sling of any of the preceding clauses, wherein the first layer is coupled to the body adjacent a perimeter edge of the body.

The sling of any of the preceding clauses, further comprising a closure mechanism disposed on the first layer of material, wherein the closure mechanism, when in a closed position, maintains the at least a portion of the body within the storage pocket.

The sling of any of the preceding clauses, wherein the closure mechanism comprises a zipper.

The sling of any of the preceding clauses, wherein the closure mechanism comprises a second layer coupled to the body, and wherein the second layer is configured to fold over the opening to maintain the at least a portion of the body within the pocket.

The sling of any of the preceding clauses, wherein the identifier comprises a color.

The sling of any of the preceding clauses, wherein the identifier comprises an alphanumeric character.

The sling of any of the preceding clauses, wherein the first layer is sewn to the body.

A sling for supporting a subject, the sling comprising: a body; one or more loops extending from the body; a first fastener coupled to a first portion of the body; and a second fastener coupled to a second portion of the body, wherein the first fastener and the second fastener cooperate to enclose the one or more loops by selectively securing the first portion of the body to the second portion of the body in a folded configuration.

The sling of any of the preceding clauses, wherein the first fastener and the second fastener are removably coupled to the body

The sling of any of the preceding clauses, further comprising a first stiffening insert and a second stiffening insert, wherein the first fastener is selectively coupled to the first stiffening insert, and wherein the second fastener is selectively coupled to the second stiffening insert.

The sling of any of the preceding clauses, wherein the first fastener and the second fastener comprise one or more magnets.

The sling of any of the preceding clauses, wherein the first fastener and the second fastener comprise a hook and loop attachment mechanism.

The sling of any of the preceding clauses, wherein the first fastener and the second fastener comprise a zipper mechanism.

The sling of any of the preceding clauses, wherein the first fastener and the second fastener comprise a snap mechanism.

The sling of any of the preceding clauses, further comprising an identifier of the sling.

The sling of any of the preceding clauses, wherein the identifier relates to a size of the sling.

The sling of any of the preceding clauses, wherein the identifier relates to a type of the sling.

The sling of any of the preceding clauses, wherein the identifier is visible to a subject while the sling is in the folded configuration.

The sling of any of the preceding clauses, wherein the first fastener extends between a first perimeter edge of the body and a second perimeter edge of the body.

The sling of any of the preceding clauses, wherein the first fastener is centrally positioned between a first perimeter edge of the body and a second perimeter edge of the body.

The sling of any of the preceding clauses, wherein the first fastener is coupled to the first portion of the body adjacent a perimeter edge of the body.

The sling of any of the preceding clauses, wherein the second fastener is coupled to the second portion of the body adjacent the perimeter edge of the body.

The sling of any of the preceding clauses, wherein the first fastener and the second fastener are laterally spaced apart from one another.

The sling of any of the preceding clauses, wherein the first fastener and the second fastener are longitudinally aligned with one another.

The sling of any of the preceding clauses, wherein the sling comprises a seated sling.

The sling of any of the preceding clauses, wherein the first fastener and the second fastener comprise one or more magnets, and wherein at least one of the one or more magnets selectively couple to a third fastener of an adjacently placed second sling.

A sling for supporting a subject thereon, the sling comprising: a body having a pocket defined therein; a stiffening insert, comprising: a first end; and a second end positioned opposite the first end, wherein the stiffening insert is sized to be received within the pocket, and wherein the second end is positioned adjacent a base of the pocket when the stiffening insert is received in the pocket; and a strap coupled to the stiffening insert, wherein the strap is wrapped around the stiffening insert for storage within the pocket when the sling is in an unfolded configuration, and wherein the strap is wrapped around the sling when the sling is in a folded configuration.

The sling of any of the preceding clauses, wherein the strap comprises a first end and a second end, and wherein the first end of the strap is secured to the first end of the stiffening insert.

The sling of any of the preceding clauses, wherein the second end of the strap extends around the second end of the stiffening insert back toward the first end of the stiffening insert when the sling is in an unfolded configuration

The sling of any of the preceding clauses, wherein the second end of the stiffening insert comprises a notch defined thereon, and wherein the strap is releasably secured in the notch when the sling is in the unfolded configuration.

The sling of any of the preceding clauses, wherein the second end of the strap is releasably secured to the first end of the stiffening insert when the sling is in the unfolded configuration.

The sling of any of the preceding clauses, wherein the strap is released from the notch when the sling is in the folded configuration, wherein the second end of the strap extends out of the slot when the sling is in a folded configuration.

The sling of any of the preceding clauses, further comprising a loop coupled to the body, and wherein the second end of the strap is coupled to the loop to maintain the sling in the folded configuration.

The sling of any of the preceding clauses, wherein the strap is flat.

The sling of any of the preceding clauses, wherein the strap comprises a rope.

The sling of any of the preceding clauses, wherein the strap comprises a ribbon.

A sling for supporting a subject thereon, the sling comprising: a body; one or more loops extending from the body; and a fastener to enclose the one or more loops by selectively securing the body in a folded configuration.

It will now be understood that the disclosure provides various solutions to securing a sling in a folded configuration to improve storage and/or identification thereof while maintaining utility and/or comfortability for a supported subject. The described solutions provide one or more fasteners on a body of a sling to facilitate uniform, compact, and/or secure storage of a particular sling. Moreover, such fasteners allow for interactions between adjacent slings to secure a plurality of slings to one another. The described solutions further allow a subject to readily, or otherwise quickly, identify a desired sling through the visualization of one or more identifiers specific to the particular sling, even when the sling is in a folded, or otherwise stored, configuration.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A sling for supporting a subject thereon, the sling comprising:
a body;
a pair of straps extending from the body; and
a first layer coupled to the body, the first layer and the body defining a storage pocket having an opening, wherein the storage pocket is sized to receive at least a portion of the body and the pair of straps therein in a folded configuration.

2. The sling of claim 1, wherein the sling comprises an identifier of the sling.

3. The sling of claim 2, wherein the first layer comprises the identifier.

4. The sling of claim 2, wherein the body comprises the identifier.

5. The sling of claim 4, wherein the first layer is substantially transparent and the identifier on the body is visible through the first layer.

6. The sling of claim 2, wherein the identifier is a color-coded identifier, a color of the color-coded identifier being associated with a feature of the sling.

7. The sling of claim 2, wherein the identifier comprises an alphanumeric character associated with a feature of the sling.

8. The sling of claim 2, wherein the identifier relates to a size of the sling or a type of the sling.

9. The sling of claim 1, wherein the first layer comprises a mesh material.

10. The sling of claim 1, wherein the sling further comprises a support handle.

11. The sling of claim 10, wherein the support handle is a shoulder loop of the sling.

12. The sling of claim 11, wherein the shoulder loop defines a connection point for a sling bar of an overhead lift.

13. The sling of claim 10, wherein the support handle is coupled to the storage pocket.

14. The sling of claim 1, wherein the first layer is coupled to the body adjacent a perimeter edge of the body.

15. The sling of claim 1, further comprising a closure mechanism disposed on the first layer of material, wherein the closure mechanism, when in a closed position, maintains the at least a portion of the body within the storage pocket.

16. The sling of claim 15, wherein the closure mechanism comprises at least one of a zipper mechanism, a fold over closure mechanism, a snap, a magnet, an interlocking fastening mechanism, and a hook and loop fastening mechanism.

17. The sling of claim 15, wherein the closure mechanism comprises a second layer coupled to the body, and wherein the second layer is configured to fold over the opening to maintain the at least a portion of the body within the pocket.

18. The sling of claim 1, wherein the body comprises a surface having a low-friction material.

19. The sling of claim 1, wherein the pair of straps are a pair of leg straps that each define a connection point for a sling bar of an overhead lift.

20. A sling for supporting a subject thereon, the sling comprising:
a body having a first portion and a second portion;
a pair of leg straps extending from the body;
a pair of shoulder loops extending from the body; and
a first layer partially coupled to the second portion of the body to define a storage pocket having a closable opening,
wherein the second portion of the body is positioned with respect to the first portion of the body to allow for the first portion of the body to be received within the storage pocket when the sling is in a folded configuration, and
wherein the pair of leg straps and/or the pair of shoulder loops are disposed within the storage pocket when the sling is in the folded configuration.
